(19) United States
(12) Patent Application Publication
(10) Pub. No.: US 2005/0031504 A1
(43) Pub. Date: Feb. 10, 2005

(54) Compact fuel cell feed processing system

(76) Inventors: Timothy R. Armstrong, Clinton, TN (US); Roddie R. Judkins, Knoxville, TN (US)

Correspondence Address: UT-Battelle, LLC;Office of Intellectual Property, One Bethal Valley Road, 4500N, MS-6258, Oak Ridge, TN, 37831, US

(21) Appl. No.: 10/635,311

(22) Filed: Aug. 6, 2003

(51) Int. Cl. B01J 8/04; H01M 8/06

(52) U.S. Cl. 422/189; 422/198; 429/17

(57) ABSTRACT

In fuel cell feed processing systems, reformate gas comprising primarily hydrogen and water vapor is produced from a mixture of gaseous fuel and air using a carbon foam heat exchanger and carbon fiber composite molecular sieve scrubber instead of conventional desulfurizers, shift reactors, and partial oxidation reactors.

The United States Government has rights in this invention pursuant to contract no. DE-AC05-00OR22725 between the United States Department of Energy and UT-Battelle, LLC.

### FIELD OF THE INVENTION

The present invention relates to fuel cells, and more particularly to fuel cell feed processing systems wherein reformate gas comprising, primarily, hydrogen and water vapor is produced from a mixture of natural gas, gasoline, and/or other gaseous hydrocarbons with air using a carbon foam heat exchanger and carbon fiber composite molecular sieve scrubber instead of conventional desulfurizers, shift reactors, and partial oxidation reactors.

### BACKGROUND OF THE INVENTION

Typical fuel reforming systems in use today decompose complex hydrocarbon fuel into simpler compounds including H₂, CO₂, H₂O, and CH₄. Hydrocarbon fuels are fed into a fuel reformer of autothermal, steam, or microchannel type that catalyzes the fuel into a mixture called reformate. The reformate is passed through a desulfurizer to remove all sulfur bearing species in the gas stream. The reformate then goes through a shift reactor that reduces the CO to a few percent and raises the H₂ level by 10 to 12%. The final stages of the fuel processor consist of CO polishing, which eliminates all remnants of CO either by extraction or conversion to CO₂ in the partial oxidation reactor and cooling of the reformate in a heat exchanger. This current approach is not desirable for mobile or transportation equipment and most stationary applications because the apparatus required is large, complex, and expensive. For use in any of the low-temperature fuel cells the CO and CO₂ must be removed prior to the reformed gas entering the fuel cell. In the case of the polymer electrolyte membrane (PEM) fuel cell the CO is removed in a 3-stage process in which the gas undergoes a low-temperature and high-temperature water gas shift process in which the CO is converted to CO₂ in a partial oxidation reactor. In addition, the catalyst in the shift reactor is sensitive to small amounts of sulfur in the gas stream and therefore, any residual H₂S must be removed prior to entry into the shift reactor. Improvements in the process that lead to a reduction in the mass or volume of apparatus and decrease in equipment or operating costs have long been desired.

### OBJECTS OF THE INVENTION

Accordingly, objects of the present invention include an apparatus for an improved fuel cell feed processing system which is smaller and more energy-efficient than existing equipment. Reformate gas of hydrogen and water vapor is produced from a mixture of hydrocarbons and air using a carbon foam heat exchanger and carbon fiber composite molecular sieve scrubber and further methods for utilizing the apparatus to provide a gas stream composed of only H₂ and H₂O. Further and other objects of the present invention will become apparent from the description contained herein.

### SUMMARY OF THE INVENTION

In accordance with one aspect of the present invention, the foregoing and other objects are achieved by a fuel cell feed processing system which comprises a fuel reformer of a type selected from the group consisting of autothermal type fuel reformers, steam type fuel reformers, and microchannel type fuel reformers for catalyzing fuel forming a gas mixture comprising H₂, CO, CO₂, and CH₄ called reformate, and further comprising a means for introducing fuel and air into the reformer; a heat exchanger, configured and communicably connected to the fuel reformer so that reformate from the fuel reformer is passed into and through the heat exchanger for cooling the reformate; and, a scrubber, configured and communicably connected to the heat exchanger so that the cooled reformate from the heat exchanger may be passed into and through the scrubber for removing CO, CO₂, and H₂S from the cooled reformate, the scrubber further comprising a means for passing scrubbed reformate from the scrubber; the reformer, the heat exchanger, and the scrubber being communicably connected in series so that gaseous material may pass through the reformer, the heat exchanger and the scrubber sequentially.

In accordance with a second aspect of the present invention, a fuel cell feed processing system comprises a fuel reactor for catalyzing fuel forming a gas mixture called reformate comprising essentially H₂, CO, CO₂, and H₂O, the fuel reactor further comprising means for introducing fuel and air into the fuel reactor; a heat exchanger, configured and communicably connected to the fuel reactor so that reformate from the fuel reactor is passed into and through the heat exchanger for cooling the reformate; a scrubber, configured and communicably connected to the heat exchanger so that the cooled reformate from the heat exchanger may be passed into and through the scrubber for extracting CO from the cooled reformate, the scrubber further comprising means for passing scrubbed reformate from the scrubber; and, a fuel reformer, configured and communicably connected to the scrubber so that CO isolated from the reformate in the scrubber is recycled into and through the fuel reformer for conversion to reformate, the fuel reformer being further configured and communicably connected to the heat exchanger so that reformate from the fuel reformer may be passed into and through the heat exchanger; the reactor, the heat exchanger, and the scrubber being communicably connected in series so that gaseous material may pass through the reformer, the heat exchanger, and the scrubber sequentially and the reformer connected in a parallel manner so that some material may pass from the scrubber into and through the fuel reformer and may further pass from the fuel reformer into and through the reactor at the same time material passes through the reactor, the heat exchanger, and the scrubber sequentially.

In accordance with a third aspect of the present invention, a fuel cell feed processing system comprises: a scrubber for removing sulfur bearing species from natural gas or LPG feed streams, a fuel reactor for catalyzing fuel forming a gas mixture called reformate comprising essentially H₂, CO, CO₂, H₂O, and trace amounts of CH₄, said fuel reactor further comprising means for introducing fuel and air into said fuel reactor; a heat exchanger, configured and communicably connected to said fuel reactor so that reformate from said fuel reactor is passed into and through said heat exchanger for cooling the reformate; a scrubber, configured and communicably connected to said heat exchanger so that the cooled reformate from said heat exchanger may be passed into and through said scrubber for extracting CH₄ from the cooled reformate, said scrubber further comprising means for passing scrubbed reformate from said scrubber, and a fuel reformer configured and communicably connected to said scrubber so that CH₄ isolated from the reformate in said scrubber is recycled into and through said fuel reformer for conversion to reformate, said fuel reformer being further configured and communicably connected to said heat exchanger so that reformate from the fuel reformer may be passed into and through said heat exchanger; said reactor, said heat exchanger, and said scrubber being communicably connected in series so that gaseous material may pass through said reformer, said heat exchanger, and said scrubber sequentially and said reformer connected in a parallel manner so that some material may pass from said scrubber into and through said fuel reformer and may further pass from said fuel reformer into and through said reactor at the same time material passes through said reactor, said heat exchanger, and said scrubber sequentially.

In accordance with a fourth aspect of the present invention, a fuel cell feed processing system comprises: a scrubber for removing sulfur bearing species from natural gas or LPG feed streams, a fuel reactor for catalyzing fuel forming a gas mixture called reformate comprising essentially H₂, CO, CO₂, H₂O, and trace amounts of CH₄, said fuel reactor further comprising means for introducing fuel and air into said fuel reactor; a heat exchanger, configured and communicably connected to said fuel reactor so that reformate from said fuel reactor is passed into and through said heat exchange for cooling the reformate; a scrubber, configured and communicably connected to said heat exchanger so that the cooled reformate from said heat exchanger may be passed into and through said scrubber for extracting CO₂ from the cooled reformats, a pressure swing adsorption device for separating H₂ from the remaining gases,

### BRIEF DESCRIPTION OF THE DRAWINGS

FIG. 1 is a schematic drawing showing a conventional fuel processing or reforming system.

FIG. 2 is a schematic drawing showing a preferred embodiment of the compact fuel feed processing system of the present invention.

FIG. 3 is a schematic drawing showing an alternate embodiment of the compact fuel feed processing system of the present invention.

FIG. 4 is a schematic drawing showing another embodiment having pretreatment sulfur removal.

For a better understanding of the present invention, together with other and further objects, advantages and capabilities thereof, reference is made to the following disclosure and appended claims in connection with the above-described drawings.

### DETAILED DESCRIPTION OF THE INVENTION

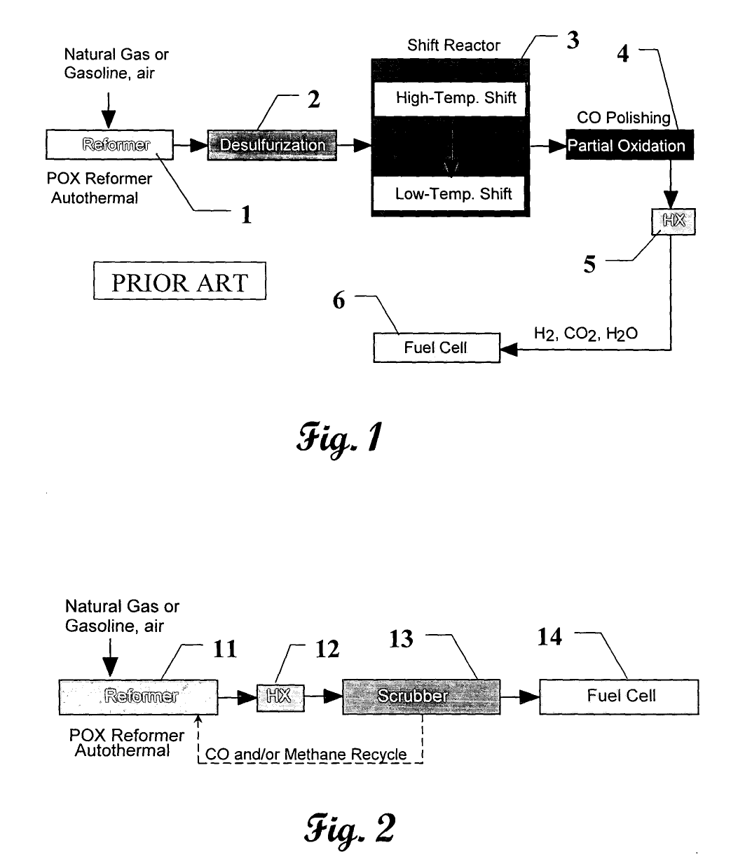

In a typical present-day fuel processing system as shown in FIG. 1, fuel such as natural gas or gasoline and air are fed into and through a fuel reformer 1, which may be of the autothermal, steam, or microchannel type, for catalyzing the fuel and forming a gas mixture comprising H₂, CO, CO₂, and small amounts of CH₄, which is called reformate. The fuel reformer 1 is communicably connected to a desulfurizer 2 so that the reformate is passed into and through the desulfurizer 2 to remove essentially all sulfur bearing species in the reformate gas stream. The desulfurizer 2 is communicably connected to a shift reactor 3 so that the desulfurized reformate is passed into and through a shift reactor 3 to reduce the CO to a few percent and to raise the H₂ level by 10 to 12%. The shift reactor 3 is communicably connected to a partial oxidation reactor 4 so that the shift-reacted reformate is passed into and through the partial oxidation reactor 4 for CO polishing. The partial oxidation reactor 4 is communicably connected to a heat exchanger 5 so that the partially oxidized reformate is passed into and through the heat exchanger 5 for cooling the partially oxidized reformats. Elements 1, 2, 3, 4, and 5 are connected via piping in series so that gaseous material passes through elements 1, 2, 3, 4, and 5 sequentially. The cooled reformate can then be piped from heat exchanger 5 to and utilized in a fuel cell 6.

In a preferred embodiment of the present invention as shown in FIG. 2, the system shown in FIG. 1 is simplified as follows: The partial oxidation reactor 4 and shift reactor 3 have been removed and the desulfurizer 2 has been modified. In this embodiment, shown in FIG. 2, fuel such as natural gas or gasoline and air are fed into and through a fuel reformer 11, which may be of the authothermal, steam, or microchannel type, for catalyzing the fuel and forming a gas mixture comprising H₂, CO, CO₂, and small amounts of CH₄, which is called reformate. The fuel reformer 11 is communicably connected to a heat exchanger 12 which, in a preferred embodiment, comprises graphite carbon foam (GCF), developed by the Oak Ridge National Laboratory in Oak Ridge, Tenn., so that the reformate is passed into and through the heat exchanger 12 for cooling the reformate. The graphite carbon foam material is further described in the following U.S. patents fully incorporated by reference herein: U.S. Pat. No. 6,033,506 issued Mar. 7, 2000; U.S. Pat. No. 6,037,032 issued Mar. 14, 2000; U.S. Pat. No. 6,387,343 issued May 14, 2002; and U.S. Pat. No. 6,261,485 issued Jul. 17, 2001. The heat exchanger 12 is communicably connected to a scrubber 13 which, in a preferred embodiment, comprises carbon fiber composite molecular sieve material (CFCMS), developed by the Oak Ridge National Laboratory in Oak Ridge, Tenn., so that the cooled reformate is passed into and through the scrubber 13 for removing essentially all CO, CO₂, and H₂S. The CFCMS material is further described in the following U.S. patents fully incorporated by reference herein: U.S. Pat. No. 5,827,355 issued Oct. 27, 1998; U.S. Pat. No. 5,912,424 issued Jun. 15, 1999; U.S. Pat. No. 5,925,168 issued Jul. 20, 1999; U.S. Pat. No. 5,972,077 issued Oct. 26, 1999, and U.S. Pat. No. 6,090,477 issued Jul. 18, 2000. Elements 11, 12, and 13 are connected via piping in series so that gaseous material passes through elements 11, 12, and 13 sequentially. Optionally, CO and/or methane can be recycled from the scrubber 13 to the reformer 11 to further improve cycle efficiency. The scrubbed reformate can then be piped from scrubber 13 and utilized in a fuel cell 14. In this embodiment, the resulting scrubbed reformate gas stream is composed essentially only of H₂ and H₂O. This embodiment provides a processing system that is smaller and more energy efficient than current-technology fuel processing systems. These advantages facilitate the use on on-board automotive and other transportation and portable applications.

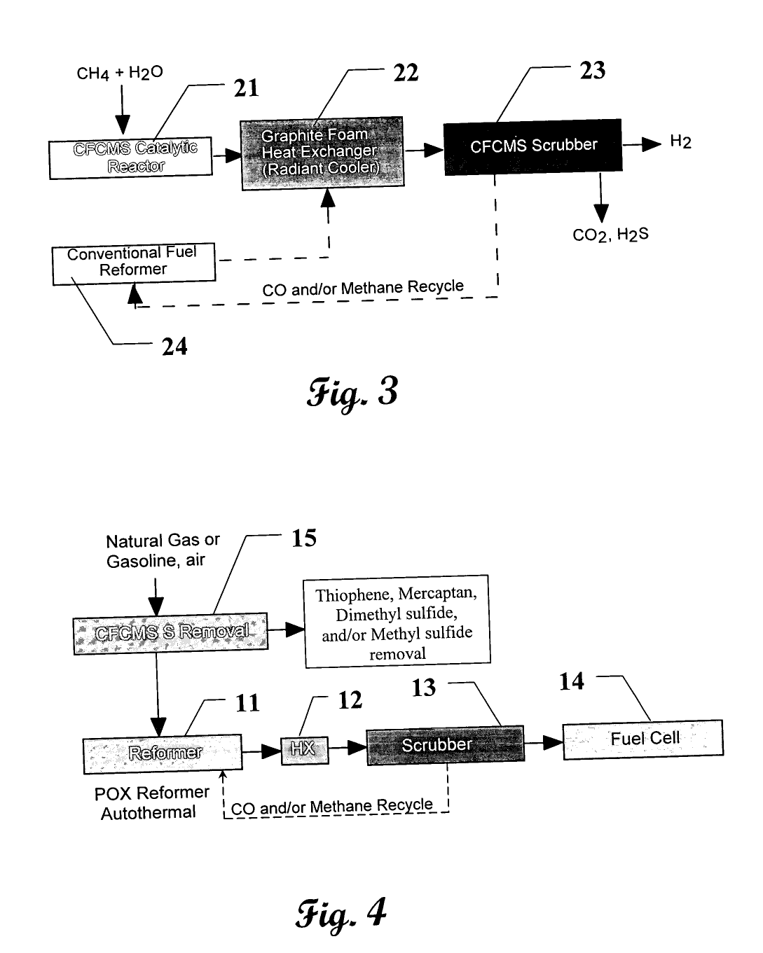

In another embodiment of the present invention as shown in FIG. 3, the CFCMS material is used as a catalyst support for a catalytic reactor reformer 21. Fuel such as CH₄ and water are fed into and through reactor 21 for catalyzing the fuel and forming a gas mixture called reformate. The reactor 21 is communicably connected to a graphitic foam heat exchanger 22, which may be configured as a radiant cooler, so that the reformate, comprising essentially H₂, CO, CO₂, and H₂O, is passed into and through the heat exchanger 22 for cooling the reformats. The heat exchanger 22 is communicably connected to a CFCMS scrubber 23 which, in a preferred embodiment is a two-stage unit capable of isolating CO and/or methane by adsorption on a CFCMS variant activated to develop micropore characteristics, i.e., pore width, pore volume, and surface area, that provide specificity for CO and/or methane adsorption and, thus, removal from the gas stream, so that the cooled reformate is passed into and through the CFCMS scrubber 23 to extract CO and/or methane from the reformate. The CFCMS scrubber is communicably connected to a conventional fuel reformer 24 so that CO and/or methane from the CFCMS scrubber 23 is recycled into and through the fuel reformer 24 for conversion to reformate. The fuel reformer 24 is further communicably connected to the cooler 22 so that the reformate from the fuel reformer 24 is passed into and through the heat exchanger 22. Elements 21, 22, and 23 are connected via piping in series so that material passes through elements 21, 22, and 23 sequentially. Element 24 is connected in a recycle or parallel manner so that some material may pass from element 23 through element 24 and back to element 22 at the same time material is passed through elements 21, 22, and 23 sequentially.

The same CO and/or methane recycle concept can be applied in the conventional fuel processing system shown in FIG. 1 and the compact fuel processing system shown in FIG. 2. In either the embodiment of FIG. 1 or the embodiment of FIG. 2, a reformer may be employed to convert any hydrocarbon, or certain oxygen-containing derivatives of hydrocarbons (such as ethanol, for example), to a mixture, reformate, composed primarily of CO and H₂, with some diluents and/or contaminant gases such as CO₂, CH₄, and H₂S, depending on the purity of the primary fuel and the effectiveness of the reformer in the conversion. The pertinent reformer reactions are:

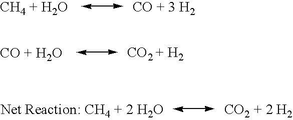

The process of removing sulfur compounds may be conducted, and the equipment therefor located, at a variety of locations. In one embodiment shown in FIG. 4, sulfur compounds can be removed from a stream of natural gas at or near the gas wellhead using a CFCMS pre-scrubber 15 activated to develop micropore characteristics, i.e., pore width, pore volume, and surface area, which provide specificity for sulfur compound adsorption. In other embodiments, sulfur compounds may be removed from a stream of fuel at or near a point of use of the fuel, including points along a fuel supply pipline or at the final use point for the fuel.

While there have been shown and described what are at present considered the preferred embodiments of the invention, it will be obvious to those skilled in the art that various changes and modifications can be prepared therein without departing from the scope of the inventions defined by the appended claims.

1. A fuel cell feed processing system comprising:
A A fuel reformer further comprising a means for introducing gaseous fuel and air into said reformer, said reformer selected from at least one of the group consisting of autothermal, steam, and microchannel types,
B A heat exchanger communicably connected to said fuel reformer, and
C A scrubber communicably connected to said heat exchanger and further comprising a means for passing scrubbed reformate from said scrubber;
wherein said reformer, said heat exchanger, and said scrubber are communicably connected in series so that gaseous material may pass through said reformer, said heat exchanger and said scrubber sequentially.

2. The fuel cell feed processing system as described in claim 1 wherein said heat exchanger comprises graphitic carbon foam.

3. The fuel cell feed processing system as described in claim 2 wherein said graphitic carbon foam heat exchanger is a radiant cooler.

4. The fuel cell feed processing system as described in claim 1 wherein said scrubber comprises carbon fiber composite molecular sieve material.

5. The fuel cell feed processing system as described in claim 1 wherein said catalytic fuel reactor is located at a point of fuel supply.

6. The fuel cell feed processing system as described in claim 1 wherein said catalytic fuel reactor is located at a point of fuel usage.

7. The fuel cell feed processing system as described in claim 1 further comprising a means for recycling gases from said scrubber to said reformer wherein said recycled gases are selected from at least one of the group consisting of carbon monoxide and methane.

8. The fuel cell feed processing system as described in claim 1 further comprising a pre-scrubber for removal of sulfur compounds, said pre-scrubber further comprising CFCMS material.

9. A fuel cell feed processing system comprising:
A A catalytic fuel reactor comprising a catalyst, a catalyst support and a means for introducing gaseous fuel and air into said catalytic fuel reactor, said catalyst support further comprising carbon fiber composite molecular sieve material;
B A heat exchanger communicably connected to said fuel reactor;
C A scrubber communicably connected to said heat exchanger, said scrubber further comprising a means for passing scrubbed reformate from said scrubber, and
D A fuel reformer communicably connected to said scrubber and said heat exchanger;
wherein said reactor, said heat exchanger, and said scrubber are communicably connected in series so that gaseous material may pass through said reformer, said heat exchanger, and said scrubber sequentially; said reformer being connected in parallel so that a portion of said gaseous material may be recycled from said scrubber into and through said fuel reformer and returning to said heat exchanger.

10. The fuel cell feed processing system as described in claim 9 wherein said heat exchanger comprises graphitic carbon foam.

11. The fuel cell feed processing system as described in claim 10 wherein said graphitic carbon foam heat exchanger is configured as a radiant cooler.

12. The fuel cell feed processing system as described in claim 9 wherein said scrubber comprises carbon fiber composite molecular sieve material.

13. The fuel cell feed processing system as described in claim 12 wherein said carbon fiber composite molecular sieve material is activated to adsorb and remove recycled gas from said gaseous material, wherein said recycled gas is selected from at least one of the group consisting of carbon monoxide and methane.

14. The fuel cell feed processing system as described in claim 12 wherein said scrubber is a two-stage unit capable of isolating carbon monoxide by adsorption.

15. The fuel cell feed processing system as described in claim 9 wherein said catalytic fuel reactor is located at a point of fuel supply.

16. The fuel cell feed processing system as described in claim 9 wherein said catalytic fuel reactor is located at a point of fuel usage.

17. The fuel cell feed processing system as described in claim 9 further comprising a means for recycling gases from said scrubber to said heat exchanger wherein said recycling gases are selected from at least one of the group consisting of carbon monoxide and methane.

18. The fuel cell feed processing system as described in claim 9 further comprising a pre-scrubber for removal of sulfur compounds, said pre-scrubber further comprising CFCMS material.

19. A method for processing fuel cell feed comprising the sequential steps of:
A Reforming a gaseous fuel input in a fuel reformer thereby forming a gas mixture comprising H₂, CO, CO₂, and CH₄, called reformate,
B Cooling said reformate using a heat exchanger communicably connected to said fuel reformer,
C Scrubbing said cooled reformate, in a scrubber communicably connected to said heat exchanger, thereby removing CO, CO₂, H₂S, and CH₄ from the cooled reformate,
D Supplying the cooled and scrubbed reformate to a fuel cell for power generation.

20. The method of claim 19 further comprising the step of recycling a portion of the cooled and scrubbed reformate back into the reformer wherein said portion comprises at least one of the gases selected from the group consisting of carbon monoxide and methane.

21. The method of claim 19 wherein said gaseous fuel input is selected from at least one of the group consisting of natural gas, gasoline, and air.

22. The method of claim 19 further comprising the initial step of pre-scrubbing the gaseous fuel input to remove at least one of the sulfur compounds selected from the group consisting of thiophenes, mercaptans, dimethyl sulfide, and methyl sulfide.
